(19) United States
(12) Patent Application Publication
(10) Pub. No.: US 2021/0304674 A1
(43) Pub. Date: Sep. 30, 2021

(54) OPTOELECTRONIC EMITTING DEVICE AND METHOD FOR CONTROLLING AN OPTOELECTRONIC EMITTING DEVICE

(71) Applicant: OSRAM OLED GmbH, Regensburg (DE)

(72) Inventors: Armin WETTERER, Regensburg (DE); Hubert HALBRITTER, Dietfurt-Toeging (DE); Mikko PERAELAE, Tampere (FI)

(21) Appl. No.: 17/265,062

(22) PCT Filed: Jul. 30, 2019
(86) PCT No.: PCT/EP2019/070515

§ 371 Date: Feb. 1, 2021

(30) Foreign Application Priority Data
Aug. 3, 2018 (DE) 10 2018 118 974.5

(51) Int. Cl. G09G 3/3233

(52) U.S. Cl. CPC G09G 3/3233; G09G 2300/0819; G09G 2320/0247; G09G 2330/02; G09G 2320/0233

(57) ABSTRACT

An optoelectronic emitting device includes a plurality of optoelectronic semiconductor components with a respective drive circuit. Each of said driving circuits includes a first circuit branch having said respective optoelectronic semiconductor component and a first transistor for controlling the current flow through said optoelectronic semiconductor component, and a capacitor for driving said first transistor with said capacitor voltage. The first circuit branches of the drive circuits of a first group of the optoelectronic semiconductor components are connected between a supply potential and a common first reference potential line. The capacitors of the drive circuits of the first group of the optoelectronic semiconductor components are coupled to a common second reference potential line.

The present application claims priority of the German patent application No. 10 2018 118 974.5, which was filed with the German Patent and Trademark Office on Aug. 3, 2018. The disclosure content of the German patent application No. 10 2018 118 974.5 is fully incorporated herein by reference in the disclosure of the present application.

The present invention relates to an optoelectronic emitting device and a method for controlling an optoelectronic emitting device.

Drive circuits for optoelectronic semiconductor components, such as LEDs, which are used in particular in displays, can use a common reference potential line for the current of the optoelectronic semiconductor component and the programming current.

With a high-impedance reference potential line, this arrangement can lead to signal interference, in particular to so-called ground bounce, since the current through the optoelectronic semiconductor component and the programming voltage are applied simultaneously, resulting in an additional—variable—voltage component. This voltage component can falsify the programming voltage and thus change the brightness and homogeneity of the displayed content in an undesirable way.

The present invention is based, inter alia, on the task of creating an optoelectronic emitting device with which signal interference can be avoided or at least reduced. Furthermore, a method for controlling an optoelectronic emitting device shall be specified.

A problem of the invention is solved by an optoelectronic emitting device with the features of claim 1. A problem of the invention is further solved by a respective optoelectronic emitting device according to the features of claims 7 and 12, respectively, and by a process with the features of claim 10.

Preferred embodiments and further developments of the invention are indicated in the dependent claims.

An optoelectronic emitting device according to a first aspect of the present application comprises a plurality of optoelectronic semiconductor components. Each of the optoelectronic semiconductor components is assigned a respective control circuit.

Each of the driving circuits comprises a first circuit branch, which includes the respective optoelectronic semiconductor component and a first transistor for controlling the current flow through the optoelectronic semiconductor component. In addition, each of the drive circuits comprises a capacitor for driving the first transistor with the capacitor voltage.

A first group of optoelectronic semiconductor components comprises a subgroup of the optoelectronic semiconductor components of the optoelectronic emitting device. The first circuit branches of the driving circuits of the first group are coupled with a common first reference potential line. Consequently, a respective reference potential connection of the first circuit branches can be connected to the first reference potential line.

Furthermore the capacitors of the control circuits of the first group are coupled to a common second reference potential line.

Accordingly, a respective reference potential connection of the capacitors can be connected to the second reference potential line. The first and the second reference potential line are separate reference potential lines and are especially ground potential lines.

The optoelectronic emitting device according to the first aspect makes it possible to reduce or completely eliminate signal interference, especially ground bounce. Furthermore, when the optoelectronic emitting device is used in a display, transparency can be increased and control circuits can be simplified.

The electromagnetic radiation emitted by optoelectronic semiconductor components can be, for example, light in the visible range, ultraviolet (UV) light and/or infrared light. The optoelectronic semiconductor components can be designed as light emitting diodes (LED), organic light emitting diodes (OLED), light emitting transistors or organic light emitting transistors. The optoelectronic semiconductor components can be part of an integrated circuit in different designs.

The optoelectronic semiconductor components can be realized especially as optoelectronic semiconductor chips.

In addition to the optoelectronic semiconductor components and their control circuits, the optoelectronic emitting device may also contain other semiconductor devices and/or other components.

The optoelectronic emitting device can be used, for example, in any type of display, i.e. optical display devices, especially in variable traffic displays, in industrial or medical applications for displaying data, in video walls, in automotive applications or in other suitable applications.

Within a respective control circuit, the optoelectronic semiconductor component and the first transistor, in particular its current-carrying path, may be connected in series and may be connected to the first reference potential line in a suitable manner. The first transistor can be used to control the current flow through the optoelectronic semiconductor component and thus its luminosity. A first terminal of the capacitor can be connected to a control terminal of the first transistor. The second terminal of the capacitor can be connected to the second reference potential line.

The first reference potential line and/or the second reference potential line can be made of a transparent, electrically conductive oxide. Transparent conducting oxides (TCO) are electrically conductive materials with a relatively low absorption of electromagnetic radiation in the visible light range. In particular, the first reference potential line and/or the second reference potential line can be made of indium tin oxide (ITO).

According to one embodiment, the first reference potential line is made of a transparent, electrically conductive oxide, especially indium tin oxide, and the second reference potential line is made of a material other than a transparent, electrically conductive oxide. Since the first reference potential line is thus essentially transparent, it can be designed comparatively wide, while the second reference potential line, over which only small currents flow, can be designed comparatively narrow to minimize loss of transparency.

The optoelectronic semiconductor components can be arranged in a matrix, especially an array, of rows (or rows) and columns.

The optoelectronic semiconductor components of the first group can be arranged in the same row or column.

A second group of optoelectronic semiconductor components can consist of another subgroup of the optoelectronic semiconductor components of the optoelectronic emitting device. The first circuit branches of the driving circuits of the second group may be coupled to a common third reference potential line. The capacitors of the control circuits of the second group may be coupled to a common fourth reference potential line. If the optoelectronic semiconductor components of the first group are arranged in the same line, the optoelectronic semiconductor components of the second group can also be arranged in another common line. If the optoelectronic semiconductor components of the first group are arranged in the same column, the optoelectronic semiconductor components of the second group can be arranged in another common column.

The third and fourth reference potential lines are separate reference potential lines and especially ground potential lines.

Accordingly, the optoelectronic emitting device may comprise further groups of optoelectronic semiconductor components, each of which is arranged in the same row or column and electrically coupled to two separate reference potential lines.

Each control circuit can have a second circuit branch, which contains the capacitor and a second transistor for coupling the capacitor to a programming line. The second transistor can be connected between the programming line and the first terminal of the capacitor. When the second transistor is turned on, i.e., its current carrying path is low impedance, the capacitor is connected to the programming line and can be programmed, i.e., charged to a specific voltage.

The first transistor and/or the second transistor can be thin-film transistors (TFT).

An optoelectronic emitting device according to a second aspect of the present application comprises a plurality of optoelectronic semiconductor components with a respective drive circuit.

Each control circuit comprises a first and a second circuit branch. The first circuit branch comprises the respective optoelectronic semiconductor component and a first transistor for controlling the current flow through the optoelectronic semiconductor component. The second circuit branch comprises a capacitor for driving the first transistor with the capacitor voltage and a second transistor for coupling the capacitor to a programming line.

Furthermore, the first circuit branch comprises a third transistor.

The third transistor blocks a current flow through the optoelectronic semiconductor component when the second transistor electrically couples the capacitor to the programming line. This means that the current flow through the semiconductor device is blocked during programming of the capacitor or the control circuit.

It may also be provided that the third transistor allows a current to flow through the optoelectronic semiconductor component if the second transistor is switched off, i.e. its current-carrying path is high-impedance and the capacitor is thus electrically decoupled from the programming line.

The optoelectronic emitting device according to the second aspect makes it possible to reduce or even eliminate signal interference, especially ground bounce.

The optoelectronic emitting device according to the second aspect may have the above described designs of the optoelectronic emitting device according to the first aspect. In contrast to the optoelectronic emitting device according to the first aspect, the first and second circuit branches of the control circuits can be coupled to the same common reference potential line.

Furthermore, a control terminal of the third transistor can be connected to a control terminal of the second transistor. In this case, the two transistors can be designed in such a way that the third transistor blocks when the second transistor allows current to flow through its current carrying path and the third transistor allows current to flow through its current carrying path when the second transistor blocks.

The first transistor and the third transistor can be connected in series. Especially the current-carrying paths of the first transistor and the third transistor can be connected in series.

The optoelectronic emitting device may also include a control unit which is used in particular to control the second and third transistors. The control unit may be designed to control the second and third transistors in such a way that the third transistor blocks a current flow through the semiconductor optoelectronic device when the second transistor electrically couples the capacitor to the programming line.

A method according to a third aspect of the present application is used to control an optoelectronic emitting device. The optoelectronic emitting device comprises a plurality of optoelectronic semiconductor components with a respective control circuit. Each of the driving circuits comprises a first circuit branch comprising the respective optoelectronic semiconductor component, a first transistor for controlling the current flow through the optoelectronic semiconductor component and a third transistor, and a second circuit branch comprising a capacitor for driving the first transistor with the capacitor voltage and a second transistor for coupling the capacitor to a programming line.

The method comprises providing a common control signal and controlling at least one of the drive circuits with the common control signal such that the second transistor electrically couples the capacitor to the programming line and simultaneously the third transistor blocks current flow through the optoelectronic semiconductor component. In particular, both the second transistor and the third transistor are simultaneously supplied with the common control signal.

Furthermore, at least one control circuit can be controlled in such a way that the second transistor electrically decouples the capacitor from the programming line and at the same time the third transistor allows a current flow through the optoelectronic semiconductor component.

An optoelectronic emitting device according to a fourth aspect of the present application, which is also capable of preventing or at least reducing signal interference, comprises a plurality of optoelectronic semiconductor components with a respective drive circuit. Each of the driving circuits comprises a first circuit branch comprising the respective optoelectronic semiconductor component and a first transistor for controlling the current flow through the optoelectronic semiconductor component, and a capacitor for driving the first transistor with the capacitor voltage. Each of the driving circuits is electrically coupled to a reference potential layer. Consequently, each of the driving circuits can be connected to the reference potential layer.

In particular the reference potential layer is a ground potential layer.

The optoelectronic emitting device according to the fourth aspect may comprise the above described configurations of the optoelectronic emitting device according to the first aspect.

In contrast to the optoelectronic emitting device according to the first aspect, in the optoelectronic emitting device according to the fourth aspect the first circuit branches and the capacitors of the control circuits are electrically coupled to the reference potential layer.

The optoelectronic semiconductor components can be arranged in a first level. The reference potential layer can extend in a second plane parallel to the first plane. The reference potential layer can have a large surface area and extend over several optoelectronic semiconductor components and their control circuits.

An electrically insulating layer, especially a dielectric layer, may be placed between the control circuits and the reference potential layer. The electrical connection between the control circuits and the reference potential layer may be provided by plated-through holes which are led from the control circuits through the electrically insulating layer to the reference potential layer.

To avoid loss of transparency, the reference potential layer can be made of a transparent, electrically conductive oxide and especially of indium tin oxide.

The reference potential layer can consist of a continuous layer, but can alternatively also comprise a close-meshed network of a multitude of conductor tracks or nanowires.

A display, that is to say an optical indicator, according to a fifth aspect of the present application, may contain one or more optoelectronic emitting devices according to one of the first, second and fourth aspects.

In the following, examples of the invention are explained in detail with reference to the attached drawings. In these show schematically:

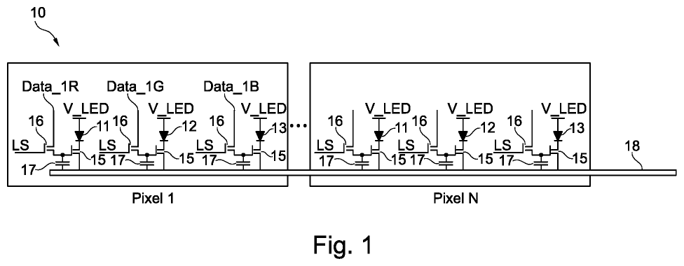

FIG. 1 section of a circuit diagram of a conventional design example of an optoelectronic emitting device;

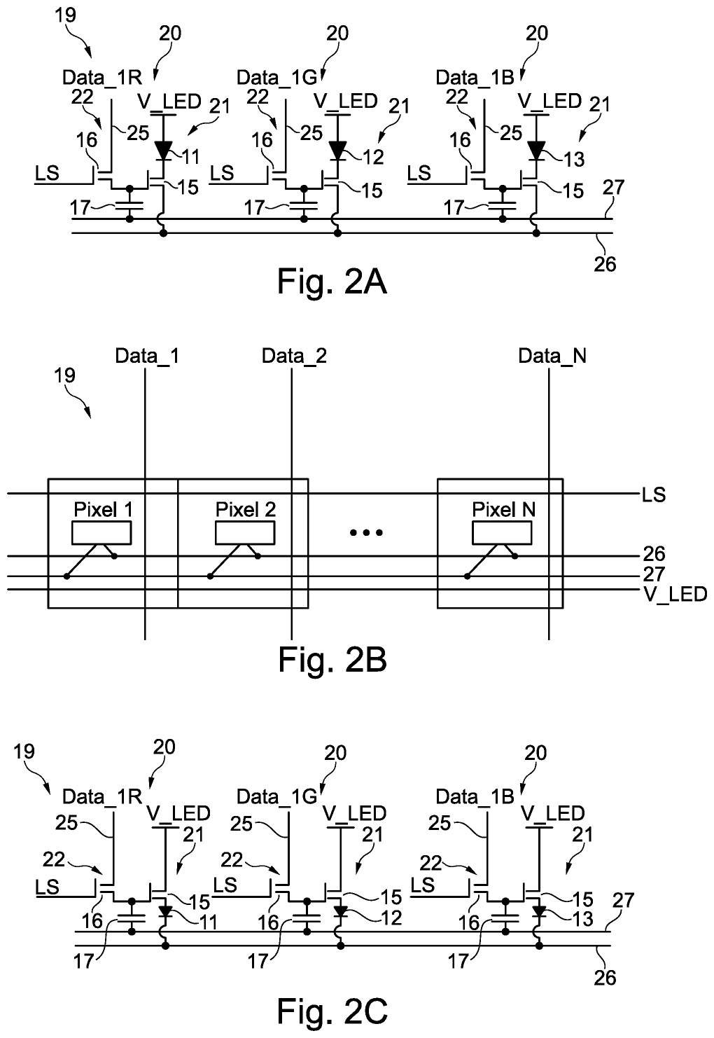

FIG. 2A to 2C Excerpts of circuit diagrams of an example of an optoelectronic emitting device according to the first aspect;

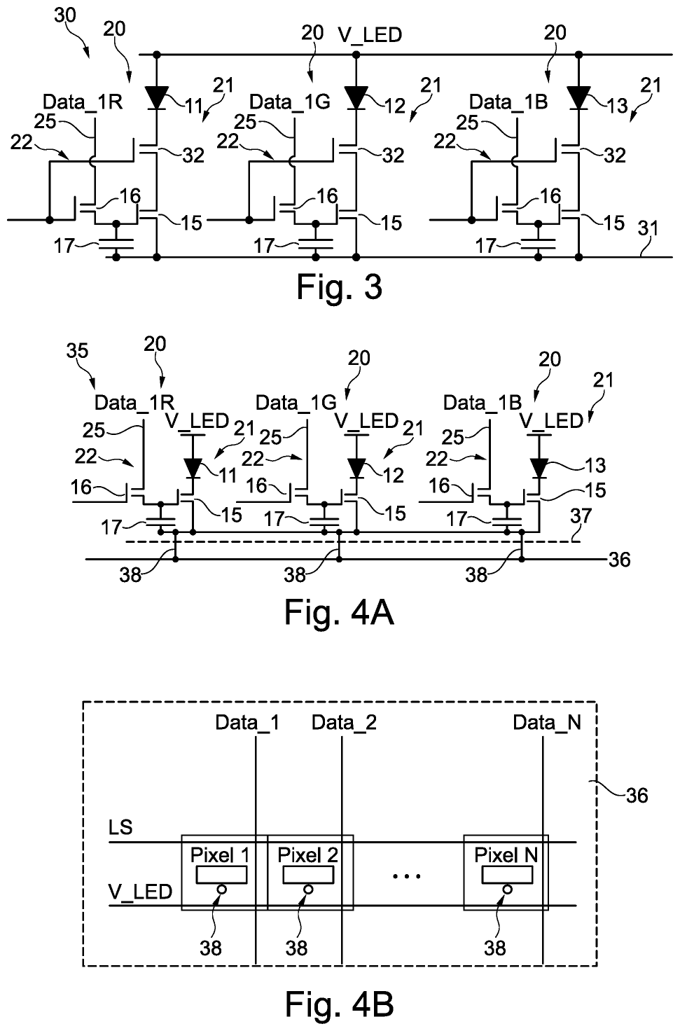

FIG. 3 section of a circuit diagram of an example of an optoelectronic emitting device design according to the second aspect; and

FIGS. 4A and 4B Excerpts of circuit diagrams of a design example of an optoelectronic emitting device according to the fourth aspect.

In the following detailed description, reference is made to the attached drawings, which form part of this description and in which, for illustration purposes, specific examples of designs are shown in which the invention can be exercised. Since components of design examples can be positioned in a number of different orientations, the terminology of directions is for illustration purposes only and is in no way restrictive. It is understood that other examples of execution can be used and structural or logical changes can be made without deviating from the scope of protection. It is understood that the features of the different execution examples described herein may be combined with each other, unless specifically stated otherwise.

The following detailed description should therefore not be understood in a restrictive sense. In the figures, identical or similar elements are marked with identical reference signs, where appropriate.

FIG. 1 shows an excerpt from a schematic circuit diagram of an optoelectronic emitting device 10, which is not in accordance with the invention and is a component of a display. FIG. 1 shows a line of a pixel matrix. The line contains N pixels. Only pixels 1 and N are shown.

Each of the pixels has three subpixels with a respective LED 11, 12 or 13 for the colors red, green and blue. Each subpixel is assigned a control circuit, which is also called a 2T1C pixel circuit, because it comprises a first transistor 15, a second transistor 16 and a capacitor 17.

Ground terminals of the first transistor 15 and the capacitor 17 of each control circuit are connected to a common ground potential line 18.

A supply voltage V_LED is applied to the anode terminals of diodes 11, 12, 13. A programming voltage Data_ij can be applied to the current-carrying paths of the second transistors 16, where i denotes the respective pixel (i=1, . . . , N) and j indicates the color of the subpixel, i.e. red, green, or blue (j=R, G, B). Furthermore, a signal LS (line select) can be applied to the control terminals of the second transistors 16 in order to apply the programming voltages Data_ij to the capacitors 17.

A disadvantage of the circuit shown in FIG. 1 is that the current flowing through the LEDs 11, 12, 13, which is connected to the common ground potential line 18, causes a voltage loss over the length of the ground potential line 18. For example, a design of the ground potential line 18 as an aluminum conductor track with a width of approx. 10 μm, a thickness of 500 nm and a length of 10 cm (corresponds to the display width) results in a resistance of 520 Ohm. If a LED current of for example 200 μA flows on the ground potential line 18, this leads to a voltage swing of up to 1 V between the first pixel and the N. pixel.

Since the capacitors 17 have one connection to the common ground potential line 18, the voltage swing over the entire length of the ground potential line 18 distorts the gate-source programming voltage. Depending on the brightness, the current of the display as well as the image content, this can lead to signal interference, especially disturbing flickering, as well as different brightness.

FIG. 2A shows a section of a schematic circuit diagram of an optoelectronic emitting device 19, which is part of a display.

The optoelectronic emitting device 19 shown in FIG. 2A is an example of an optoelectronic emitting device as described in the first aspect of the application.

In FIG. 2A, only one pixel is shown for ease of graphical representation. The optoelectronic emitting device 19 has a matrix of pixels arranged in rows and columns, all of which comprise the same structure as the pixel shown in FIG. 2A.

Each of the pixels comprises three sub-pixels with a respective optoelectronic semiconductor component in the form of an LED 11, 12 or 13 for the colors red, green or blue. Each pixel is assigned a control circuit 20, which is similar to the control circuit shown in FIG. 1. The control circuits 20 each contain a first circuit branch 21 and a second circuit branch 22 as well as a first transistor 15, a second transistor 16 and a capacitor 17. The first and second transistors 15, 16 are thin film transistors.

In the first circuit branch 21 of a respective control circuit 20 the respective LEDs 11, 12 or 13 and the current-carrying path, i.e. the drain-source path, of the first transistor 15 are connected in series. In the second circuit branch 22 one terminal of the drain-source path of the second transistor 16 is connected to a programming line 25 and the other terminal of the drain-source path of the second transistor 16 is connected to a terminal of the capacitor 17. This terminal of capacitor 17 is also connected to a control terminal, i.e. the gate terminal, of the first transistor 15.

A supply voltage V_LED is applied to the anode terminals of LEDs 11, 12 and 13 during operation of the optoelectronic emitting device 19. A programming voltage Data_1R, Data_1G or Data_1B can be applied to the programming lines 25. Furthermore, a signal LS can be applied to the control connections, i.e. the gate connections, of the second transistors 16. The LS signal is used to select a line of the pixel matrix. Consequently, the signal LS is identical for all pixels and subpixels of a line.

A reference potential connection of the first circuit branch 21, i.e. the connection of the drain-source path of the first transistor 15 facing away from LED 11, 12 or 13, is connected to a common first ground potential line 26, i.e. a common first reference potential line. Furthermore, a reference potential connection of capacitor 17 is connected to a common second ground potential line 27, i.e. a common second reference potential line.

All reference potential connections of the first circuit branches 21 of a line, i.e. a first group of pixels or LEDs, are connected to the first ground potential line 26 and all reference potential connections of the capacitors 17 of a line are connected to the second ground potential line 27. This is shown schematically in FIG. 2B. There the pixels 1 to N of a line of the optoelectronic emitting device 19 are shown, which are connected to the first and second ground potential line 26 and 27, respectively, as described above. For each additional line of the optoelectronic emitting device 19, two separate ground potential lines are provided.

To program the pixels, the second transistors 16 of a line are simultaneously driven with a voltage LS, which causes the drain-source paths of the second transistors 16 to become electrically conductive and thus the respective programming voltage Data_ij is applied to the capacitors 17. The voltage to which the respective capacitor 17 is charged by the programming is applied to the gate terminal of the respective first transistor 15 and determines the gate-source voltage of the first transistor 15.

The gate-source voltage of the first transistor 15 determines the current that can flow through the respective LED 11, 12 or 13, which in turn determines the brightness of the light emitted by the respective LED 11, 12 or 13.

By separating the ground potential line into a first ground potential line 26 and a separate second ground potential line 27, it is prevented that the comparatively high currents flowing through the first ground potential line 26 falsify the programmed voltages of the capacitors 17.

The voltage losses on the first ground potential line 26 can be compensated by a higher supply voltage V_LED, since the first transistors 15 are operated in saturation and the dynamic voltage drop at the drain-source section of the respective first transistor 15 drops. This has no influence on the LED current.

The first ground potential line 26, over which the LED current flows, is made of a transparent, electrically conductive oxide, especially indium tin oxide. Since only small currents flow via the second ground potential line 27, this line can be relatively narrow and made of a transparent, electrically conductive oxide or another electrically conductive material.

FIG. 2A shows a so-called common anode arrangement in which the supply voltage V_LED is applied to the anode terminals of LEDs 11, 12 and 13. Typically, the first transistors 15 are n-channel TFTs with a channel of indium-gallium-zinc oxide (IGZO). Alternatively, LEDs 11, 12 and 13 can also be arranged in a so-called common cathode arrangement.

A common cathode arrangement is shown as an example in FIG. 2C.

In the first circuit branches 21, the respective LED 11, 12 or 13 are arranged between the first transistor 15 and the first ground potential line 26, i.e. the cathode terminals of the LEDs 11, 12 and 13 are connected to the first ground potential line 26. Here the first transistors 15 can be implemented as p-channel TFTs or n-channel TFTs. Otherwise the circuit from FIG. 2C is identical to the circuit from FIG. 2A.

FIG. 3 shows a section of a schematic circuit diagram of an optoelectronic emitting device 30, which is part of a display.

The optoelectronic emitting device 30 shown in FIG. 3 is an example of an optoelectronic emitting device according to the second aspect of the application. Furthermore, a method of controlling the optoelectronic emitting device 30 is described below. This method is an example of a method according to the third aspect of the application.

The optoelectronic illuminator 30 is identical to the optoelectronic illuminator 19 shown in FIG. 2A except for the differences noted below.

Unlike the optoelectronic emitting device 19, the optoelectronic emitting device 30 does not comprise two separate ground potential lines, but only one ground potential line 31 per pixel line. The ground potential line 31 is connected to both the ground connections of the first circuit branches 21 and the ground connections of the capacitors 17.

Furthermore in the first circuit branches 21, a third transistor 32 with the LEDs 11, 12 or 13 and the first transistors 15 are connected in series. The third transistors 32 can be arranged as shown in FIG. 3 between LED 11, 12 or 13 and the first transistor 15 or alternatively between the line for the supply voltage V_LED and LED 11, 12 or 13. The third transistors 32 can be designed as thin film transistors and especially as p-channel TFTs.

Furthermore, the second transistor 16 and the third transistor 32 are controlled by a control unit not shown in FIG. 3. During programming of the subpixels, the second transistors 16 are switched on to allow charging of the capacitors 17 to the desired voltage, and the third transistors 32 are switched off so that no LED current flows during programming. Once programming is complete, the second transistors 16 are switched off and the third transistors 32 are switched on to allow LED current to flow.

In the execution example shown in FIG. 3, the second transistors 16 are designed as n-channel TFTs and the third transistors 32 as p-channel TFTs. Furthermore, the gate terminals of the second and third transistors 16, 32 are connected to each other and are controlled by the same signal LS. This causes the second and third transistors 16, 32 to be switched on and off alternately.

As a result, signal disturbances such as ground bounce are eliminated, because during programming no LED currents and therefore only small currents flow via the ground potential line 31. Consequently, a thin ground potential line 31 can be used, which increases the transparency of the display.

The voltage losses on the ground potential line 31 caused by the LED currents can be compensated by a higher supply voltage V_LED, since the first transistors 15 are operated in saturation and the dynamic voltage drops at the drain-source path of the respective first transistor 15. This has no influence on the LED current.

FIG. 4A shows an excerpt from a schematic circuit diagram of an optoelectronic emitting device 35, which is part of a display.

The optoelectronic emitting device 35 shown in FIG. 4A is an example of an optoelectronic emitting device design according to the fourth aspect of the application.

The optoelectronic emitting device 35 is identical to the optoelectronic emitting device 19 shown in FIG. 2A except for the differences noted below.

The optoelectronic emitting device 35 does not comprise two separate ground potential lines, but a common large-area ground potential layer 36, to which the ground connections of the first circuit branches 21 and the ground connections of the capacitors 17 are connected.

The ground potential layer 36 is isolated from the supply voltage V_LED and the control signals by a large-area dielectric layer 37. From the control circuits 20 of each subpixel a respective via 38 extends through the dielectric layer 37 to the ground potential layer 36.

The LEDs 11, 12 and 13 can be arranged in one plane, and the first and second transistors 15, 16 can be arranged in another plane. Both layers can have a certain thickness to accommodate the components in the respective layer. The ground potential layer 36 can be arranged in a further plane parallel to the first two planes.

The ground potential layer 36 can be made of a transparent, electrically conductive oxide and especially of indium tin oxide, which increases the transparency of the ground potential layer 36.

In FIG. 4B the ground potential layer 36 is shown in a top view.

As in FIG. 4B, the ground potential layer 36 can consist of a continuous layer that can extend over all pixels. The LED current is distributed over the entire ground potential layer 36, resulting in lower voltage drops.

Alternatively, the ground potential layer 36 can consist of a close-meshed network of conductor paths, especially nanowires.

This reduces the capacitive load on the gate terminals of the second transistors 16 and the programming lines 25.

### REFERENCE CHARACTER LIST

10 optoelectronic emitting device
11 LED
12 LED
13 LED
15th transistor
16 second transistor
17 capacitor
18 ground potential line
19 optoelectronic emitting device
20 Control circuit
21 first circuit branch
22 second circuit branch
25 programming line
26 ground potential line
27 second ground potential line
30 optoelectronic emitting device
31 ground potential line
32 transistor
35 optoelectronic emitting device
36 mass potential layer
37 dielectric layer
38 plated through hole

1-6. (canceled)

7. An optoelectronic emitting device, with:
a plurality of optoelectronic semiconductor components having a respective drive circuit,
wherein each of said drive circuits comprises a first circuit branch and a second circuit branch,
wherein the first circuit branch comprises the respective optoelectronic semiconductor component, a first transistor for controlling the current flow through the optoelectronic semiconductor component, and a third transistor,
the second circuit branch comprising a capacitor for driving the first transistor with the capacitor voltage and a second transistor for coupling the capacitor to a programming line,
the third transistor blocking current flow through the optoelectronic semiconductor component when the second transistor couples the capacitor to the programming line, and
the third transistor having a control terminal connected to a control terminal of the second transistor.

8. The optoelectronic emitting device according to claim 7, wherein the first transistor and the third transistor are connected in series.

9. The optoelectronic emitting device according to claim 7, having a control unit which controls the second and third transistors in such a way that the third transistor blocks a current flow through the optoelectronic semiconductor component when the second transistor couples the capacitor to the programming line.

10. A method for controlling an optoelectronic emitting device,
wherein the optoelectronic emitting device comprises a plurality of optoelectronic semiconductor components having a respective drive circuit,
wherein each of said drive circuits comprises a first circuit branch and a second circuit branch,
wherein the first circuit branch comprises the respective optoelectronic semiconductor component, a first transistor for controlling the current through the optoelectronic semiconductor component, and a third transistor,
the second circuit branch comprising a capacitor for controlling the first transistor with the capacitor voltage and a second transistor for coupling the capacitor to a programming line, and
wherein the method comprises:
providing a control signal; and
controlling at least one of the drive circuits with the control signal in such a way that the second transistor couples the capacitor to the programming line and at the same time the third transistor blocks a current flow through the optoelectronic semiconductor component.

11. The method according to claim 10, wherein the at least one drive circuit is controlled in such a way that the second transistor decouples the capacitor from the programming line and at the same time the third transistor permits a current flow through the optoelectronic semiconductor component.

12. An optoelectronic emitting device, comprising:
a plurality of optoelectronic semiconductor components having a respective drive circuit,
wherein each of said driving circuits comprises a first circuit branch comprising the respective optoelectronic semiconductor component and a first transistor for controlling the current flow through said optoelectronic semiconductor component, and a capacitor for driving said first transistor with said capacitor voltage,
wherein the drive circuits are coupled to a reference potential layer, and
wherein the optoelectronic semiconductor components are arranged in a first plane and the reference potential layer extends in a second plane which is parallel to the first pane.

13. (canceled)

14. The optoelectronic emitting device according to claim 12, wherein an electrically insulating layer is arranged between the drive circuits and the reference potential layer and a through hole is led from each drive circuit through the electrically insulating layer to the reference potential layer.

15. The optoelectronic emitting device according to claim 12, wherein the reference potential layer is made of a transparent, electrically conductive oxide and in particular of indium tin oxide.

16. The optoelectronic emitting device according to claim 12, wherein the reference potential layer comprises a network of a plurality of conductor paths.

17. A display with one or more optoelectronic emitting devices according to claim 7.

18. The optoelectronic emitting device according to claim 7, each driving circuit comprising a second circuit branch comprising the capacitor and a second transistor for coupling the capacitor to a programming line.

19. The optoelectronic emitting device according to claim 7, wherein at least one of the first transistor or the second transistor is a thin-film transistor.

20. The optoelectronic emitting device according to claim 7, wherein at least one of the first reference potential line or the second reference potential line is made of a transparent, electrically conductive oxide comprising indium tin oxide.

21. The optoelectronic emitting device according to claim 7, wherein the optoelectronic semiconductor components are arranged in a matrix of rows and columns and the optoelectronic semiconductor components of the first group are arranged in a same row or column.
